(19) United States
(12) Patent Application Publication
(10) Pub. No.: US 2026/0022073 A1
(43) Pub. Date: Jan. 22, 2026

(54) Powder for Manufacturing Ceramic Structures and Method for Manufacturing Ceramic Structure Using the same

(71) Applicant: CANON KABUSHIKI KAISHA, Tokyo (JP)

(72) Inventors: Tomohiro UNNO, Shizuoka (JP); Koji NISHIKAWA, Chiba (JP); Shunsuke MURAKAMI, Tokyo (JP); Yasushi SHIMIZU, Kanagawa (JP)

(21) Appl. No.: 18/661,394

(22) Filed: May 10, 2024

Related U.S. Application Data
(63) Continuation of application No. PCT/JP2022/041997, filed on Nov. 10, 2022.

(30) Foreign Application Priority Data
Nov. 12, 2021 (JP) 2021-184894

(51) Int. Cl. C04B 35/10; B33Y 70/00; C04B 35/653

(52) U.S. Cl. CPC C04B 35/10; B33Y 70/00; C04B 35/653

(57) ABSTRACT

A powder, used in an additive manufacturing method in which fabrication is performed by irradiation with laser light, contains particles A of an inorganic compound, particles B of another inorganic compound with a lower thermal conductivity than particles A, and absorber particles exhibiting higher absorptive capacity for light with wavelengths present in the laser light than particles A and particles B. The powder satisfies the following relationships (1) to (4):

$$5. \leq W ( A ) ; \qquad ( 1 )$$

$$5. \leq W ( B ) ; \qquad ( 2 )$$

$$60. \leq W ( A ) + W ( B ) ; and \qquad ( 3 )$$

$$1.2 \leq D ( A ) / D ( B ) \leq 400. , \qquad ( 4 )$$

wherein D(A) represents the average particle size in μm of particles A, D(B) represents the average particle size in μm of particles B, W(A) represents the mass percent of particles A in % by weight in the powder, and W(B) represents the mass percent of particles B in % by weight.

### CROSS-REFERENCE TO RELATED APPLICATIONS

This application is a Continuation of International Patent Application No. PCT/JP2022/041997, filed Nov. 10, 2022, which claims the benefit of Japanese Patent Application No. 2021-184894, filed Nov. 12, 2021, both of which are hereby incorporated by reference herein in their entirety.

### TECHNICAL FIELD

The present disclosure relates to a powder used for forming ceramic structures by laser irradiation.

### BACKGROUND ART

Additive manufacturing technology (3D printers), which can form arbitrary shapes based on the shape data of a three-dimension model, is becoming increasingly popular. Recently, a technique has been required for manufacturing high-precision, high-strength ceramic structures using inorganic compound materials such as metal oxides or metal carbides, in addition to resins and metals that have been long used as fabrication materials for 3D printers.

PTL 1 disclosed a raw material powder suitable for powder bed fusions and cladding methods. Specifically, absorber particles having a higher absorptive capacity for light with wavelengths present in laser light than other compositions are added a powder containing inorganic compound particles with low absorptive capacity for light, such as Al₂O₃ or ZrO₂, which are main constituents of ceramic structures. The presence of absorber particles in the raw material powder reduces the diffusion of laser light within the powder to achieve locale heating and melting, enabling the fabrication of ceramic structures with high mechanical strength and high fabrication precision.

PTL 2 disclosed the technique of fabricating an object by a powder bed fusion method using a powder mainly containing SiO₂ to which absorber particles are added as the raw material, and heat-treating (hereinafter expressing firing) the resulting object. This firing melts the constituents around cracks formed in the ceramic structure during shaping and fills the cracks, thus enabling mechanically strong ceramic structures to be obtained.

### CITATION LIST

### Patent Literature

PTL 1 Japanese Patent Laid-Open No. 2019-19051
PTL 2 Japanese Patent Laid-Open No. 2021-66177

Ceramic structures have a wide range of applications, and certain electrical properties may be required in addition to mechanical and thermal properties. For example, ceramic structures used in the telecommunication, aerospace, and medical fields require a low dielectric loss tangent of less than 0.01 at a frequency of 1 MHz. The dielectric loss tangent is a numerical value that expresses the degree of electrical energy loss within a dielectric. The lower the dielectric loss tangent of dielectrics, the more accurately high-frequency electrical signals can be transmitted.

The dielectric loss tangent tends to increase as small voids in the ceramic structure ranging from a few micrometers to several tens of micrometers in major axis increase. When voltage is applied to ceramic structures, local discharges (partial discharges) occur in voids in the ceramic structures. This is probably a factor in increasing the dielectric loss tangent. Therefore, to achieve a ceramic structure with a low dielectric loss tangent, small internal voids should be minimized.

In PTL 1, the melting point of the raw material powder is reduced by mixing Al₂O₃ with ZrO₂ or Gd₂O₃, which can form eutectics with Al₂O₃. In combined particles of different compositions, such as Al₂O₃ and ZrO₂ or Al₂O₃ and Gd₂O₃, heat from laser irradiation may not be transferred to the particles with the lower conductivity because their thermal conductivities are different. Consequently, the state of melted particles becomes nonuniform between the compositions in such a manner that some of the particles remain unmelted and form voids in the fabricated object, causing the dielectric loss tangent to tend to increase.

In PTL 2, the ceramic structure is fired after fabrication to reduce cracks, thereby increasing the mechanical strength. However, it is unclear whether the small voids can be reduced to the extent of achieving a low dielectric loss tangent.

While powder bed fusion methods enable the fabrication of ceramic structures with high mechanical strength at high precision, as described above, studies on reducing the dielectric loss tangent of ceramic structures is not in progress.

### SUMMARY OF DISCLOSURE

The present disclosure provides a raw material powder capable of manufacturing ceramic structures with a low dielectric loss tangent by a powder bed fusion method at high precision.

A powder according to the present disclosure is used in an additive manufacturing method in which fabrication is performed by irradiation with laser light. The powder contains particles A of an inorganic compound, particles B of another inorganic compound with a lower thermal conductivity than particles A, and absorber particles exhibiting higher absorptive capacity for light with wavelengths present in the laser light than particles A and particles B. The powder satisfies the following relationships (1) to (4):

$$5. \leq W ( A ) ; \qquad ( 1 )$$

$$5. \leq W ( B ) ; \qquad ( 2 )$$

$$60. \leq W ( A ) + W ( B ) ; and \qquad ( 3 )$$

$$1.2 \leq D ( A ) / D ( B ) \leq 400. , \qquad ( 4 )$$

wherein D(A) represents the average particle size in μm of particles A, D(B) represents the average particle size in μm of particles B, W(A) represents the mass percent of particles A in % by weight in the powder, and W(B) represents the mass percent of particles B in % by weight.

Further features of the present disclosure will become apparent from the following description of exemplary embodiments with reference to the attached drawings.

### BRIEF DESCRIPTION OF DRAWINGS

FIG. 1A is a schematic diagram illustrating a process for manufacturing a ceramic structure by a powder bed fusion method.

FIG. 1B is a schematic diagram illustrating a process for manufacturing a ceramic structure by a powder bed fusion method.

FIG. 1C is a schematic diagram illustrating a process for manufacturing a ceramic structure by a powder bed fusion method.

FIG. 1D is a schematic diagram illustrating a process for manufacturing a ceramic structure by a powder bed fusion method.

FIG. 1E is a schematic diagram illustrating a process for manufacturing a ceramic structure by a powder bed fusion method.

FIG. 1F is a schematic diagram illustrating a process for manufacturing a ceramic structure by a powder bed fusion method.

FIG. 1G is a schematic diagram illustrating a process for manufacturing a ceramic structure by a powder bed fusion method.

FIG. 1H is a schematic diagram illustrating a process for manufacturing a ceramic structure by a powder bed fusion method.

FIG. 2 is an image binarized from an observation image of a ceramic structure surface observed under a laser microscope.

### DESCRIPTION OF EMBODIMENTS

Although the powder according to the present disclosure will now be described more specifically, the disclosure is not limited to the following specific embodiments, and modifications may be made within the scope of the technological concept of the disclosure.

### Ceramic Structure

Ceramic structures in the present disclosure are made up of inorganic compounds, which may be crystalline, amorphous, or a mixture of crystalline and amorphous states. The inorganic compounds include oxides, nitrides, carbides, borides of metals and nonmetals, and the present disclosure is suitable particularly for manufacturing metal oxide or nonmetal oxide ceramic structures. In the following description, ceramic structures may be simply mentioned as structures.

### Voids in Ceramic Structure

In general, structures manufactured by additive manufacturing technology contain many voids, cracks, and other spaces of various sizes. In the present disclosure, spaces with a major axis of 1 μm to 50 μm are referred to as “voids”, and spaces with a major axis of more than 50 μm are referred to as “cracks”. The reason why a structure contains a large number of voids is probably that while a raw material powder is irradiated with laser light, areas where the powder is not sufficiently dissolved are created.

Fabrication by a powder bed fusion method is performed by irradiating a raw material powder with laser light while scanning the laser light based on the shape data of a three-dimensional model to be manufactured. From the viewpoint of fabrication efficiency, the scanning speed is preferably higher, and a raw material powder that can be melted by short-time laser irradiation is desirable.

Al₂O₃, which is widely used as a ceramic material, has a high melting point of about 2072° C. and low absorptive capacity for light of wavelengths in a wide range from ultraviolet to infrared regions. Accordingly, in PTLs 1 and 2, Al₂O₃, a material capable of forming a eutectic with Al₂O₃ (eutectic material), and an absorber are mixed to reduce the melting point of the raw material powder before fabrication.

Two types of particles that are different in composition, crystal structure, or the like have a difference in thermal conductivity. When a mixed powder of such two types of particles is irradiated with laser light, heat is conducted in different ways depending on the type of particles. Accordingly, particles with lower thermal conductivity are not melted even though particles with higher thermal conductivity are melted, and thus, the state of melted powder may be non-uniform. In portions where particles are not sufficiently melted, voids among the particles cannot be filled and remain in the structure.

In PTLs 1 and 2, Al₂O₃, and ZrO₂, Gd₂O₃, and SiO₂ as materials that form eutectic with Al₂O₃ are described. Table 1 presents the thermal conductivity, melting point, and specific gravity of Al₂O₃ and these eutectic materials. All of these eutectic materials have lower thermal conductivities than Al₂O₃.

TABLE 1

| | Al₂O₃ | SiO₂ | ZrO₂ | Gd₂O₃ |
|---|---|---|---|---|
| Thermal conductivity | 30.0 | 1.5 | 3.0 | 10.6 |
| [W/(m · K)] | | | | |
| Specific gravity | 3.97 | 2.2-2.65 | 5.68 | 7.4 |
| Melting point (° C.) | 2072 | 1713 | 2715 | 2310 |

Among the eutectic materials presented in Table 1, SiO₂ has a lower melting point than Al₂O₃. Accordingly, when a raw material powder in which Al₂O₃ and SiO₂ are mixed is used, SiO₂ is expected to melt preferentially to fill voids. In reality, however, when ceramic structures were fabricated using the mixed powder of Al₂O₃ and SiO₂ described in PTLs 1 and 2, voids in the structure could not be sufficiently reduced, failing to achieve low dielectric loss tangent. When the percentage of SiO₂ in the raw material powder was increased, or when the power of laser light irradiation was increased to increase the heating temperature, some structures melted and lost their shape.

PTLs 1 and 2 use a mixed powder of Al₂O₃ particles and SiO₂ particles with larger particle sizes than Al₂O₃ particles. The present inventors succeeded in uniformly melting different types of particles with different thermal conductivities in a powder by reducing the particle size of particles with lower thermal conductivity (reducing particle size) than that of particles with higher thermal conductivity. Reducing the particle size of particles with lower thermal conductivity can bring the time required for them to melt close to the time required for the particles with higher thermal conductivity to melt, thereby enabling the powder in the laser irradiation section to melt uniformly.

Thus, the inventors obtained a powder that can provide ceramic structures with few voids and a low dielectric loss tangent, suitable as a raw material in additive manufacturing technology through many attempts to vary the ratio of particle sizes and mixing ratio of plural types of particles with different thermal conductivities contained in the powder.

The present disclosure will now be described closure in detail.

### Raw Material Powder

The raw material powder according to the present disclosure contains particles A of an inorganic compound, particles B of another inorganic compound with a lower thermal conductivity than particles A, and absorber particles exhibiting higher absorptive capacity for light with wavelengths present in the laser light than particles A and particles B. Particles A, particles B, and absorber particles are different types from each other. The expression “different types” used herein means that the constituents, chemical composition, crystallinity, and other properties of the plural types of particles are different among the types.

Particles A, particles B, and absorber particles are respective units independently present in the powder. For example, when particles A are present in the powder as secondary particles, each formed by binding plural primary particles together, the secondary particles are particles A.

Particles A and B of inorganic compounds are main components of the ceramic structure. Particles A and B are collections of single-composition particles, composed of a metal or nonmetal oxide or a nitride with low absorptive capacity for infrared light. The raw material powder may be expressed as a mixed powder containing powder A composed of a plurality of particles A, powder B composed of a plurality of particles B, and an absorber powder composed of a plurality of absorber particles. Particles A and B, which are main components of the ceramic structure, are each contained in 5.0 [% by weight] or more in the raw material powder, and their total accounts for 60% by weight or more of the raw material powder. When the mass percents of particles A and particles B in the raw material powder are expressed as W(A) [weight %] and W(B) [weight %], respectively, the following relationships hold:

$$5. \leq W ( A ) \qquad ( 1 )$$

$$5. \leq W ( B ) \qquad ( 2 )$$

$$60. \leq W ( A ) + W ( B ) \qquad ( 3 )$$

### Inorganic Particles A and B

The particles with relatively high thermal conductivity of the particles contained as the main components of the ceramic structure in the raw material powder correspond to particles A, and the particles with lower thermal conductivity than particles A correspond to particles B. Particles A and particles B may be selected according to the properties required for the ceramic structure to be manufactured. For manufacturing an oxide-based ceramic structure, both particles A and B are preferably composed of metal oxide and/or semimetal oxide.

For example, particles A preferably contain a composition selected from the group consisting of Al₂O₃, ZrO₂·Y₂O₃, Y₂O₃, and SiO₂, particularly Al₂O₃. Al₂O₃, which has particularly high thermal conductivity among metal and semimetal oxides, can quickly conduct heat emitted from the absorber particles that absorb laser light to the entirety of the powder, enabling shorter-time fabrication of an object. In addition, Al₂O₃ forms eutectics with various inorganic compounds, allowing fabrication using combinations of various compositions.

Preferably, particles A contain a composition that forms a eutectic with the composition of particles B. When particles A and particles B form a eutectic, the melting point of the raw material powder can be reduced. For example, even if particles A contain a high-melting-point composition, the melting point can be reduced by forming a eutectic with the composition in particles B, and thus the powder becomes likely to melt. When the melt of fused and mingled inorganic particles A and B is solidified, crystalline phases are mingled among plural compositions and form complex and intricate interfaces, and the interfaces are less likely to crack along the interfaces even by applying external stress, thus exhibiting enhanced strength.

Inorganic particles B may be selected from, for example, the group consisting of SiO₂, ZrO₂·Y₂O₃, 3Al₂O₃·2SiO₂, and 2MgO·2Al₂O₃·5SiO₂.

The melting point of inorganic particles B, having a relatively low thermal conductivity, is preferably lower than that of inorganic particles A and, more preferably, 1900° C. or less, which can be easily reached by laser irradiation. The heat obtained from the absorber particles during laser irradiation facilitates rapid melting. Additionally, such particles are expected to produce the effect of allowing firing at a relatively low temperature that does not damage the shape of fabricated structures to melt the composition of inorganic particles B to fill and reduce the remaining voids in the structure. From these viewpoints, inorganic particles B are particularly preferably SiO₂. SiO₂ has a low melting point of 1650° C. and can form eutectics with other compositions such as Al₂O₃.

Preferred combinations of particles A and particles B for manufacturing oxide-based ceramic structures include Al₂O₃—Gd₂O₃, Al₂O₃—GdAlO₃, Al₂O₃—Y₂O₃, Al₂O₃—YAlO₃, Al₂O₃—Y₃Al₅O₁₂, Al₂O₃—ZrO₂, and Al₂O₃—SiO₂.

The present inventors found through their diligent studies that when the main components of the ceramic structure, particles A and particles B, further satisfy the following relationship (4), the melting speeds of particles A and particles B, which have different thermal conductivities, can be close to each other.

$$1. 2 \leq D ( A ) / D ( B ) \leq 400 \qquad ( 4 )$$

D(A) [μm] and D(B) [μm] represent the particle size of particles A and the particle size of particles B, respectively.

The particle size of inorganic particles A refers to the average particle size of a plurality of inorganic particles A, and the particle size of inorganic particles B refers to the average particle size of a plurality of inorganic particles B. When inorganic particles A and inorganic particles B are in single-particle states, their average particle sizes are applied as they are. When inorganic particles A and inorganic particles B are formed by aggregating minute particles, the average particle size of aggregated inorganic particles is applied. The minute particles forming inorganic particles A or inorganic particles B respectively have the same composition but may contain other particles of different compositions.

The particle size can be calculated in the following manner. Powder is measured with a laser diffraction/scattering particle size analyzer. The median diameter (also referred to as median value), which is the particle size (D50) at which the cumulative frequency of measured powder reaches 50%, is taken as the average particle size.

In the present disclosure, when the raw material powder contains particles A and particles B with a lower thermal conductivity than particle A, which are the main components of the ceramic structure, voids in the resulting ceramic structure are reduced. This effect is more pronounced particularly when particles A and particles B have a thermal conductivity of K(A) [W/m·K] and a thermal conductivity of K(B) [W/m·K], respectively, and K(A)/K(B) ranges from 2.0 to 50.0, particularly from 3.0 to 30.0.

In relationship (4), D(A)/D(B) preferably ranges 1.4 to 150, more preferably 1.4 to 60. When D(A)/D(B) is in such a range, times required for particles A and B to melt can be close, and accordingly, the entire powder in the laser light irradiation section can be uniformly melted. Consequently, voids are further reduced, achieving a still lower dielectric loss tangent.

The particle size D(A) of particles A is preferably 2.0 [μm] to 100 [μm], more preferably 5.0 [μm] to 70.0 [μm], and still more preferably 10.0 [μm] to 30.0 [μm]. Also, the particle size D(B) of particles B is preferably 0.1 [μm] to 50.0 [μm], more preferably 1.0 [μm] to 40.0 [μm], and still more preferably 5.0 [μm] to 20.0 [μm].

W(A) is preferably 8.0 [% by weight] to 88.0 [% by weight], more preferably 18.0 [% by weight] to 78.0 [% by weight]. When W(A) is in such a range, the heat emitted from absorber particles by laser irradiation can be efficiently conducted to the entire powder in the irradiation section because of the presence of a certain amount of particles A, which have a higher thermal conductivity. Consequently, ceramic structures can be fabricated in a shorter time.

When the melting point of particles B is lower than that of particles A, W(B) is preferably 10.0 [% by weight] to 90.0 [% by weight], more preferably 20.0 [% by weight] to 80.0 [% by weight]. When W(B) is in such a range, particles B, which have a low melting point, melt easily to fill voids, facilitating the achievement of low dielectric loss tangent. In addition, the firing step described later can be performed at a low temperature according to the melting point of particles B, facilitating combined improvement with fabrication precision.

W(A)+W(B) is preferably 80.0 [% by weight] or more, more preferably 90.0 [% by weight] or more.

### Absorber Particles

The absorber particles exhibit the highest absorptive capacity of the plural types of particles contained in the raw material powder for light with wavelengths present in the laser light used for fabrication. The absorptance of the absorber particles is preferably 10% or more, more preferably 40% or more, and still more preferably 60% or more for light with wavelengths present in the laser light used.

The absorber particles efficiently absorb laser light used in manufacturing and increase their own temperature. The heat emitted from the absorber particles is conducted to other particles within an area equivalent to the focal size of the laser light to heat and melt these other particles, thus enabling fabrication using additive manufacturing technology. Also, the absorber particles enable local heating of areas equivalent to the focal size of the laser light, increasing fabrication precision.

The absorptance of the absorber particles can be measured with a common spectrometer. More specifically, a sample dish filled with an absorber by itself is placed in an integrating sphere and irradiated with an assumed wavelength (near the laser wavelength used in manufacturing), and the absorptance is calculated from the ratio of the value measured in the electromagnetic spectrum to the value measured without the sample.

Preferably, the absorber particles contain at least one selected from the group consisting of SiO, TiO, Ti₂O₃, ZnO, antimony-doped tin oxide (ATO), indium-doped tin oxide (ITO), MnO, MnO₂, Mn₂O₃, Mn₃O₄, FeO, Fe₂O₃, Fe₃O₄, Cu₂O, CuO, Cr₂O₃, CrO₃, NiO, V₂O₃, VO₂, V₂O₅, V₂O₄, Co₃O₄, CoO, Tb₄O₇, Pr₆O₁₁, ZrN, ZrC, ZrSi, and AlN. Since absorber particles of these compounds have high light absorptive capacity for infrared light, they can absorb laser light and provide the periphery with the amount of heat required to melt the entire powder in the laser light irradiation section.

The mass percent of the absorber particles in the raw material powder is preferably 0.1 [% by weight] to 20.0 [% by weight], more preferably 0.2 [% by weight] to 20.0 [% by weight], and still more preferably 0.5 [% by weight] to 20.0 [% by weight]. When the absorber particles are contained in such a range, at least one absorber particle can exist within an area equivalent to the focal size of the laser light, thus reducing nonuniform fabrication depending on positions.

For the above reasons, W(A)+W(B) in formula (3) is preferably less than 99.9 [% by weight], more preferably less than 99.8 [% by weight], and still more preferably less than 99.5 [% by weight].

The particle size of the absorber particles is preferably 0.1 [μm] to 20.0 [μm], more preferably 1.0 [μm] to 10.0 [μm], and still more preferably 1.0 [μm] to 5.0 [μm]. In such a range, the absorber particles can be dispersed in the powder without aggregating. For the particle size of the absorber particles, as with particles A and B, when the particles are in a single-particle state, their particle size is applied as they are, and when the particles are formed by aggregating minute particles, the particle size of aggregated particles is applied.

Unlike the main components of the ceramic structure, particles A and B, the absorber particles are intended to absorb laser light and are often not an important component in imparting desired properties to the ceramic structure. In such a case, adding absorber particles increases unnecessary constituents, making it difficult to control the properties. Accordingly, absorber particles preferably contain a semimetal element or metal element contained in particles A or particles B. The absorber particles containing the same semimetal or metal element as in particles A or particles B inhibit the addition of unnecessary constituents to the ceramic structure, facilitating the design of materials to achieve desired properties.

Absorber particles containing SiO are particularly preferred. SiO has a low melting point among the above-cited absorber particles and can melt while rapidly generating heat upon laser irradiation, enabling the fabrication of structures with few irregularities and smooth surfaces. In addition, SiO remaining in the fabricated object through firing reacts with oxygen into SiO₂. This conversion is accompanied by an increase in volume. Hence, voids can be filled effectively by the volume increase as well as by the effect of melting as described so far, further reducing the dielectric constant.

The raw material powder may contain particles C apart from particles A, particles B, and the absorber particles. When the mass percent of particles C in the raw material powder is 5.0 [% by weight] or more, particles C are also a main component of the ceramic structure. In this instance, it is preferable that particles C and particles A or particles C and particles B satisfy the relationships of the present disclosure.

The process of producing each type of the particles is not limited. A dry (fumed) process, a wet process, a vapor-phase reaction, a spray-dry process, or the like may be used.

### Step of Mixing Particles

Preferably, the absorber particles are uniformly dispersed in the powder, and the dispersity, which will be explained later, is preferably 0.80 or less. In this state, the heat generated from the absorber particles is uniformly conducted to the powder in the laser irradiation section, enabling the melting speeds of the inorganic particles apart from the absorber particles to be easily matched. Consequently, structures with few voids and a low dielectric loss tangent can be obtained.

The powder is preferably subjected to a mixing step before being used for fabricating structures. In the mixing step, a mixing apparatus, such as a V blender, a ball mill, or a rocking mixer, is preferably used.

Particularly preferably, a V blender is used from the viewpoint of uniformly dispersing the absorber particles, dispersing particles A and particles B, which have different specific gravities and particle sizes, effectively in a short mixing time, and reducing excessive impact on the particles.

### Process for Manufacturing Ceramic Structure

The powder according to the present disclosure can be used as the raw material powder for an additive manufacturing method in which heating is performed by irradiation with laser light. The process for manufacturing ceramic structures using an additive manufacturing method includes the following steps (i) and (ii). Steps (i) and (ii) are repeated according to the ceramic structure to be manufactured.
(i) Step of placing the raw material powder in the laser light irradiation section
(ii) Step of irradiating the raw material powder with laser light based on the three-dimensional fabrication data

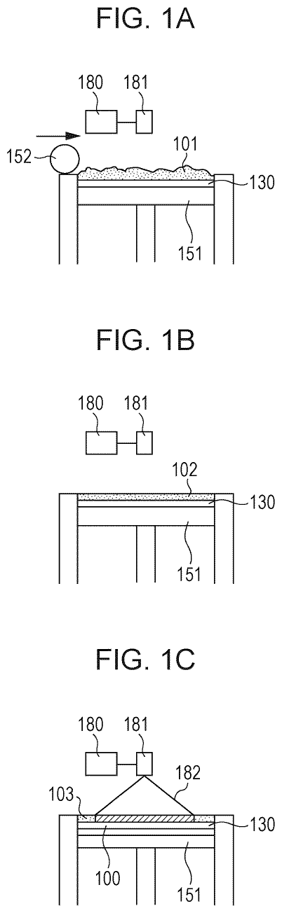

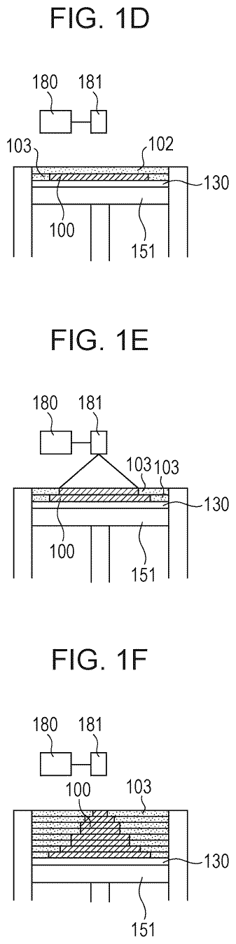

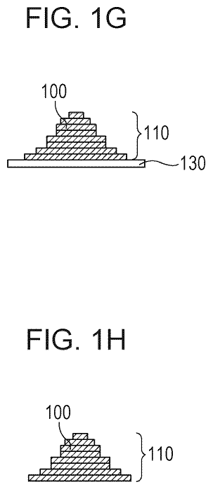

A specific example of the ceramic structure manufacturing process, using a powder bed fusion method will be described with reference to FIGS. 1A, 1B, 1C, 1D, 1E, 1F, 1G, and 1H.

First, the raw material powder 101 is placed on the fabrication surface of a base 130 set on a stage 151 and evenly spread to a predetermined thickness with a roller 152. The powder evenly spread to the predetermined thickness is called a powder layer 102 (FIGS. 1A and 1B). While a scanner section 181 operates the laser light emitted from a laser light source 180 to scan the surface of the powder layer 102 based on the three-dimensional fabrication data of the article to be manufactured, the surface is irradiated with laser light. In the region 182 irradiated with the laser light, the powder sinters or melts and then solidifies to form a solidified portion 100 (FIG. 1C). Subsequently, the stage 151 is lowered, and a new powder layer 102 is formed on the solidified portion 100 (FIG. 1D). The resulting new powder layer 102 is irradiated with the laser light in the same manner as in FIG. 1C to form a solidified portion 100 in the irradiated area. At this time, the power of the laser light may be adjusted to the extent that the surface layer on the side of the newly formed powder layer 102 of the previously formed solidified portion is melted, thus joining the previously formed solidified portion to the subsequently formed solidified portion. By repeating the series of these steps, solidified portions 100 formed layer by layer are joined to each other to form an integrated fabrication object 110 with a desired shape (FIGS. 1E and 1F). Finally, unsolidified powder 103 is removed, and, optionally, unnecessary portions of the fabricated object are removed, and the object is separated from the base (FIGS. 1G and 1H).

In the manufacturing process of the present disclosure, preferably, a step of firing the resulting ceramic structure is performed after repeating step (i) and step (ii) a number of times as necessary for fabrication. The heating method in the firing step is not limited and may be selected from resistance heating, induction heating, using an infrared lamp, a laser, an electron beam, and the like as appropriate for the purpose. Firing can further reduce voids in the structure to reduce the dielectric loss tangent. In other words, even if voids remain to some extent in the ceramic structure after fabrication, the voids can be reduced through the firing step. If firing alone does not sufficiently reduce voids, firing may be performed after impregnating the structure with a liquid containing a constituent to fill voids.

The firing temperature is preferably set to a temperature lower than the melting point of the ceramic structure and at which crystals do not grow, depending on the main components of the structure. If particles A and particles B form a eutectic, it is desirable to perform firing within the eutectic temperature+50° C. When particles B are composed of SiO₂, the firing temperature is preferably 1600° C. to 1730° C. and more preferably 1650° C. to 1710° C. In such a range, SiO₂ can melt to fill voids without the structure losing its shape.

### Powder Evaluation Methods

### Particle Size

The particle size of particles is the median diameter (also referred to as median value) that is an average particle size. The median diameter is the particle size (D50) at which the cumulative frequency of a powder reaches 50%. The average particle size can be measured with a laser diffraction/scattering particle size analyzer. If single-particle powders are not available, the mixed powder can be classified using a multiclassifier (e.g., Elbow-Jet Classifier manufactured by Nittetsu Mining) to separate the particles into respective types, and the average particle size is measured for each type.

### Thermal Conductivity

When a powder composed of all the same particles is available, 10.0 g of the powder is compressed into a cylindrical pellet of 3 cm in diameter at 30 MPa, and the thermal conductivity of the pellet is measured with a conductivity measuring apparatus.

When only mixed powder is available, the mixed powder is classified with a multiclassifier (e.g., Elbow-Jet Classifier manufactured by Nittetsu Mining) to separate the particles into respective types, and each type is pelletized as described above and measured with the thermal conductivity measuring apparatus.

### Dispersity

The dispersity evaluation index of the absorber particles is calculated using a scanning electron microscope. The powder containing the absorber particles was observed in the same field of view, magnified 500 times, at an acceleration voltage of 5.0 kV. The dispersity was calculated as described below from the observation image using an image processing software application, “ImageJ” (available from https://imagej.nih.gov/ij/).

The image was binarized so that the absorber particles were extracted, the number of absorber particles n and centroid coordinates for all absorber particles were calculated, and the distance dn min between each absorber particle and its nearest absorber particle was calculated. The dispersity was represented by the following equation, taking the minimum distances between absorber particles in the image as d ave.

Dispersity evaluation index=

$$\sqrt{\frac{{\sum }_{1}^{n} {( dn min - d ave )}^{2}}{n}} / d ave$$

The dispersity was determined according to the above-described procedure for five randomly observed fields of view, and the average was taken as the dispersity evaluation index. A smaller dispersity evaluation index indicates better dispersibility.

### Evaluation Methods for Ceramic Structures

### Voidage

The resulting ceramic structure was impregnated with 10 ml of black oil-based ink. The surface of the impregnated structure was polished with a sandpaper of 10 mm in diameter, and the polished surface was observed under an optical microscope at a magnification of 20 times.

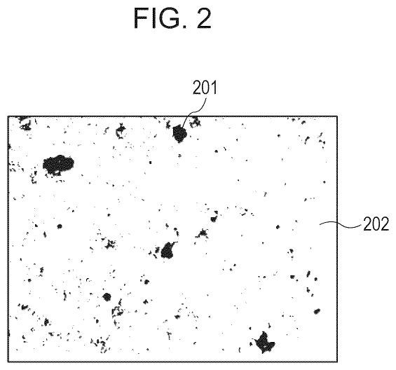

The observation image was binarized using an image processing software application, “ImageJ” (available from https://imagej.nih.gov/ij/). FIG. 2 depicts an example of binarized images. The bright region area 202 in the binarized image corresponds to the ceramic structure, and the dark regions 201 correspond to the voids in the ceramic structure. The voidage is calculated as Sd×100/S, wherein Sd represents the area of the dark regions 201 in the binarized image and S represents the area of the entire image. A smaller voidage indicates fewer voids.

In the above measurement method, ink is allowed to penetrate into smaller voids than those measured as porosity, which will be discussed later, and its appearance can be directly visualized. Therefore, the measurement method enables the evaluation of voids, which are smaller gaps that cannot be seen by the porosity measurement method. Thus, a correlation can be obtained with a physical property affected by fine gaps, such as dielectric loss tangent.

### Porosity

The porosity is examined according to R1634, which is a JIS standard for test methods for density and open porosity of sintered fine ceramics. More specifically, three cylindrical ceramic structures of 20.0 mm in diameter and 1.0 mm in thickness are subjected to the calculation of the following expression using W1 as the dry mass of the structure, W2 as the mass in water, and W3 as the water-saturated mass, and the average of the resulting values is taken as the porosity. A smaller porosity indicates fewer large pores such as cracks.

$$\{ ( W 3 - W 1 ) / ( W 3 - W 2 ) \} \times 100$$

For measuring the dry mass (W1), the ceramic structure is placed in a constant temperature and humidity oven, held at a temperature of 110° C. for 1 hour, and then cooled and weighed. The mass in water (W2) is the mass of a water-saturated sample, which is obtained by immersing a sample hung with a wire under the surface of the water in a boiling tank, boiling the sample for at least 3 hours, and allowing the sample to cool to room temperature. The sample is measured while remaining hung with the wire, and the measurement is corrected by taking into account the mass of the jig. The water-saturated mass (W3) is the measurement of the water-saturated sample after being removed from the water and quickly wiped at the surface with a wet gauze to remove water droplets.

### Dielectric Loss Tangent

A cylindrical ceramic structure with a diameter of 20.0 mm and a thickness of 1.0 mm is prepared as a sample for evaluation, and the complex permittivity is measured repeatedly three times under the condition of 1 kHz to 1 MHz in frequency. The dielectric loss tangent at 1 MHz is calculated from each measurement, and the average is taken as the dielectric loss tangent. The equation: tan δ=ε″/ε′ is used calculate the dielectric loss tangent. In the equation, δ represents the loss angle, ε″ represents the dielectric loss factor, and ε′ represents the dielectric constant.

### Dimensional Stability

For dimensional stability, the degree of errors from the target dimensions was examined. The error (%) is calculated by measuring the length of the longest edge, a 42.0 mm portion, of a 5.0 mm×42.0 mm×6.0 mm rectangular solid ceramic structure and determining the difference between the length of the actually fabricated structure and the length of the three-dimensional data prepared on a CAD. The smaller the error, the more excellent the dimensional stability.

### Surface Roughness

The surface roughness is determined by measuring the Ra value of the surface of the ceramic structure fabricated for dimensional stability evaluation with a laser microscope. The smaller the surface roughness, the smoother the surface.

### 3-Point Flexural Strength

The flexural strength of the structure is evaluated by the 3-point flexural test according to R1601, which is a JIS standard for testing methods for the flexural strength of fine ceramics at room temperature.

More specifically, 10 rectangular solid ceramic structures measuring 5.0 mm×42.0 mm×6.0 mm were fabricated and ground to 3.0 mm×30.0 mm×4.0 mm as evaluation samples.

When the distance between the external fulcrums (L) is 30 [mm], the specimen width (w) is 4 [mm], and the specimen thickness (t) is 3 [mm], the value of the expression 3×P×L/(2×w×t2) was calculated for each sample, wherein P [N] represents the maximum load at the time of failure. The average of the calculated values was taken as the 3-point flexural strength. The larger the value, the higher the strength.

### EXAMPLES

### Example 1

### Powder 1

Al₂O₃ powder with an average particle size of 24 μm, and SiO₂ powder with an average particle size of 10 μm, and SiO powder with an average particle size of 5 μm were prepared as presented in Table 2 and their thermal conductivities were measured with a thermal conductivity measuring apparatus TPS2500 (manufactured by Hot Disk). The Al₂O₃, SiO₂, and SiO powders were weighed out to 10.0 kg in total in mass percent of 54.0% by weight, 44.0%, by weight, and 2.0% by weight, respectively. The weighed powders were placed into a V blender (V20, manufactured by Seishin Enterprise) and mixed at a rotational speed of 26 rpm for 15 minutes to yield powder 1. The thermal conductivity of each powder is presented in Table 1. The observation image of powder 1 obtained with a scanning electron microscope “JSM-7800” (manufactured by JEOL Ltd.) was binarized, and the dispersity of the absorber particles was measured. The result is presented in Table 4.

### Structure 1-A

A ceramic structure was fabricated in the same manner as in the manufacturing process described with respect to FIGS. 1A, 1B, 1C, 1D, 1E, 1F, 1G, and 1H.

ProX DMP 100 (trade name), equipped with a 50 W fiber laser (65 μm in beam diameter), manufactured by 3D SYSTEM was used for fabrication.

First, powder 1 was evenly spread on the alumina base 130 with a roller to form a 20μ-thick powder layer, the first layer (FIG. 1A, FIG. 1B).

Then, the powder layer was irradiated with 47.5 W laser light while being scanned by the laser light, and the material powder in a circular area of 10 mm in diameter was melted and then solidified to yield a solidified portion 100 (FIG. 1C). At this time, the drawing speed was set at 60 mm/s, and the drawing pitch was 80 μm.

Subsequently, another 20 μm-thick powder layer was formed so as to cover the surface of the solidified portion 100 and irradiated with laser light while being scanned by the laser light, and the material powder in a circular area of 10 mm in diameter was melted and solidified to form a solidified portion 100 (FIGS. 1D and 1E).

At this time, the laser light was scanned in a direction perpendicular to the first drawing line for melting and solidifying the powder. These operations were repeated until the height of the solidified portion reached 1.0 mm, thus fabricating three cylindrical structures of 10.0 mm in diameter×1.0 mm in thickness. The three structures were used individually to evaluate voidage, porosity, and dielectric loss tangent.

The resulting structures were fired in an electric furnace. Specifically, the structures were heated to 1690° C. in 2 hours and 40 minutes under atmospheric conditions and held at 1690° C. for 20 minutes. Then, the energization was terminated, and the structures were cooled to 200° C. or less in 5.0 hours to yield three structures 1-A.

### Structure 1-B

Ten 42.0 mm×5.0 mm×6.0 mm rectangular structures were fabricated in the same manner as Structure 1-A, except that a 5.0 mm×42.0 mm rectangular area of the material powder was solidified and the operations were repeated until the height of the solidified portion reached 6.0 mm.

The resulting structures were fired in an electric furnace. Specifically, the structures were heated to 1690° C. in 2 hours and 40 minutes under atmospheric conditions and held at 1690° C. for 20 minutes. Then, the energization was terminated, and the structures were cooled to 200° C. or less in 5.0 hours to yield ten structures 1-B.

### Evaluation

Structures 1-A and structures 1-B were evaluated. Evaluation items for each structure and the results are presented in Tables 7 and 8. In some of the evaluation items, the results were ranked according to the respective criteria.

### Voidage

The voidage of structures 1-A were calculated according to the above-described evaluation method. Ranking criteria were as follows:
A: 9% or less
B: 10% to 14%
C: 15% to 19%
D: 20% or more

### Porosity

Structures 1-A were examined according to the above-described evaluation method.

### Dielectric Loss Tangent

The dielectric loss tangents of structures 1-A were evaluated according to the above-described evaluation method using 4284A precision LCR mether (manufactured by Hewlett-Packard). Ranking criteria were defined as follows:
A: Less than 0.005
B: 0.005 to less than 0.008
C: 0.008 to less than 0.010
D: 0.010 or more

### Dimensional Stability

For the resulting structures 1-B, the length of the longest edge, a 42.0 mm portion, was measured with a vernier caliper according to the above-described evaluation method, and the difference from the length of the three-dimensional data prepared on a CAD was obtained. Ranking criteria were defined as follows:
A: Less than 10%
B: 10% to less than 15%
C: 15% to less than 20%
D: 20% or more

### Surface Roughness

One of the ten structures 1-B was subjected to Ra value measurement at a magnification of 50 times according to the above-described evaluation method using the line roughness measurement mode of a laser microscope “Vk-X200” (manufactured by Keyence). Ranking criteria were defined as follows:
A: 10 μm or less
B: 10 μm to 20 μm
C: 20 μm to 30 μm
D: 31 μm or more

### 3-Point Flexural Strength

After evaluation of dimensional stability and surface roughness, ten structures 1-B were ground into ten 3.0 mm×30.0 mm×4.0 mm rectangular solids. The 3-point flexural strengths of these rectangular solids were obtained according to the above-described evaluation method.

### Examples 2 to 24

### Powders 2 to 24

Powders 2 to 24 were obtained as powders for producing the structures in Examples 2 to 24 according to the same procedure as powder 1, except that at least one of the composition, amount to be mixed, and conditions was varied for each type of particles A, particles B, and absorber particles, as presented in Table 2. In each of the powders 2 to 24, the total of the absorber particles, particles A, and particles B is 100 [% by weight]. Table 3 presents the powder mixing conditions for powders 2 to 24 and the results of the dispersity of the absorber particles obtained in the same manner as for powder 1.

### Structures 2 to 24

Structures 2-A to 24-A and structures 2-B to 24-B were fabricated and fired for Examples 2 to 24 in the same manner as structure 1-A and structure 1-B, using powders 2 to 24. The firing condition was varied according to the compositions of the particles mixed, and Table 6 shows the correspondence of each combination of structures, powder, and firing conditions.

Structures 2 to 24 were evaluated in the same manner as in Example 1, and the results are presented in Tables 7 and 8.

### Comparative Examples 1 to 7

### Powders 25 to 31

Powders 25 to 31 were obtained as powders used for producing the structures in Comparative Examples 1 to 7 according to the same procedure as powder 1, except that at least one of the composition, amount to be mixed, and conditions was varied for each type of particles A, particles B, and absorber particles, as presented in Table 4. In each of the powders 25 to 31, the total of the absorber particles, particles A, and particles B is 100 [% by weight]. Table 5 presents the powder mixing conditions for powders 25 to 31 and the results of the dispersity of the absorber particles obtained in the same manner as for powder 1.

### Structures 25 to 31

Structures 25-A to 31-A and structures 25-B to 31-B were fabricated and fired for Comparative Examples 1 to 7 in the same manner as structure 1-A and structure 1-B, using powders 25 to 31. The firing condition was varied according to the compositions of the particles mixed, and Table 6 shows the correspondence of each combination of structures, powder, and firing conditions.

Structures 25 to 31 were evaluated in the same manner as in Example 1, and the results are presented in Tables 7 and 8.

These results show that fabrication using powders containing no absorber is difficult.

Raw powders, each containing aluminum oxide particles as particles A and silicon dioxide particles as particles B and satisfying all relationships (1) to (4) were able to form ceramic structures with a voidage of 20% or less and a dielectric loss tangent of 0.01 or less. In contrast, powders that did not satisfy equation (4) resulted in a porosity of more than 20% and could not achieve a low dielectric loss tangent. In addition, powder 31, whose D(A)/D(B) exceeded 400, could not allow fabrication.

TABLE 2

| | Absorber | | | | | | | | | | Average | |
|---|---|---|---|---|---|---|---|---|---|---|---|---|
| | particles | | | | | | | | | | particle | Thermal |
| | | Average | | | | | | | | | size | conductivity |
| | | particle | Inorganic | | | | | | | | ratio | ratio |
| Ceramic | | size | particles A | | | | Inorganic particles B | | | | D(A)/ | K(A)/ |
| powder | Constituent | (μm) | Constituent | W(A) | D(A) | K(A) | Constituent | W(B) | D(B) | K(B) | D(B) | K(B) |
| Powder 1 | SiO | 5.0 | Al₂O₃ | 54.0 | 24.0 | 30.0 | Amorphous | 44.0 | 10.0 | 1.5 | 2.4 | 20.0 |
| | | | | | | | SiO₂ | | | | | |
| Powder 2 | SiO | 5.0 | Al₂O₃ | 50.0 | 24.0 | 30.0 | Amorphous | 40.0 | 10.0 | 1.5 | 2.4 | 20.0 |
| | | | | | | | SiO₂ | | | | | |
| Powder 3 | SiO | 5.0 | Al₂O₃ | 45.0 | 24.0 | 30.0 | Amorphous | 35.0 | 10.0 | 1.5 | 2.4 | 20.0 |
| | | | | | | | SiO₂ | | | | | |
| Powder 4 | SiO | 5.0 | Al₂O₃ | 72.0 | 24.0 | 30.0 | Amorphous | 26.0 | 10.0 | 1.5 | 2.4 | 20.0 |
| | | | | | | | SiO₂ | | | | | |
| Powder 5 | SiO | 5.0 | Al₂O₃ | 78.0 | 24.0 | 30.0 | Amorphous | 20.0 | 10.0 | 1.5 | 2.4 | 20.0 |
| | | | | | | | SiO₂ | | | | | |
| Powder 6 | SiO | 5.0 | Al₂O₃ | 88.0 | 24.0 | 30.0 | Amorphous | 10.0 | 10.0 | 1.5 | 2.4 | 20.0 |
| | | | | | | | SiO₂ | | | | | |
| Powder 7 | SiO | 5.0 | Al₂O₃ | 93.0 | 24.0 | 30.0 | Amorphous | 5.0 | 10.0 | 1.5 | 2.4 | 20.0 |
| | | | | | | | SiO₂ | | | | | |
| Powder 8 | SiO | 5.0 | Al₂O₃ | 30.0 | 24.0 | 30.0 | Amorphous | 68.0 | 10.0 | 1.5 | 2.4 | 20.0 |
| | | | | | | | SiO₂ | | | | | |
| Powder 9 | SiO | 5.0 | Al₂O₃ | 18.0 | 24.0 | 30.0 | Amorphous | 80.0 | 10.0 | 1.5 | 2.4 | 20.0 |
| | | | | | | | SiO₂ | | | | | |
| Powder 10 | SiO | 5.0 | Al₂O₃ | 8.0 | 24.0 | 30.0 | Amorphous | 90.0 | 10.0 | 1.5 | 2.4 | 20.0 |
| | | | | | | | SiO₂ | | | | | |
| Powder 11 | SiO | 5.0 | Al₂O₃ | 5.0 | 24.0 | 30.0 | Amorphous | 93.0 | 10.0 | 1.5 | 2.4 | 20.0 |
| | | | | | | | SiO₂ | | | | | |
| Powder 12 | SiO | 5.0 | Al₂O₃ | 54.0 | 2.0 | 30.0 | Amorphous | 44.0 | 1.0 | 1.5 | 2.0 | 20.0 |
| | | | | | | | SiO₂ | | | | | |
| Powder 13 | SiO | 5.0 | Al₂O₃ | 54.0 | 70.0 | 30.0 | Amorphous | 44.0 | 50.0 | 1.5 | 1.4 | 20.0 |
| | | | | | | | SiO₂ | | | | | |
| Powder 14 | SiO | 5.0 | Al₂O₃ | 54.0 | 24.0 | 30.0 | Amorphous | 44.0 | 20.0 | 1.5 | 1.2 | 20.0 |
| | | | | | | | SiO₂ | | | | | |
| Powder 15 | SiO | 5.0 | Al₂O₃ | 78.0 | 60.0 | 30.0 | Amorphous | 20.0 | 1.2 | 1.5 | 50.0 | 20.0 |
| | | | | | | | SiO₂ | | | | | |
| Powder 16 | SiO | 5.0 | Al₂O₃ | 78.0 | 60.0 | 30.0 | Amorphous | 20.0 | 1.0 | 1.5 | 60.0 | 20.0 |
| | | | | | | | SiO₂ | | | | | |
| Powder 17 | SiO | 5.0 | Al₂O₃ | 88.0 | 80.0 | 30.0 | Amorphous | 10.0 | 0.2 | 1.5 | 400.0 | 20.0 |
| | | | | | | | SiO₂ | | | | | |
| Powder 18 | SiO | 5.0 | Al₂O₃ | 54.0 | 24.0 | 30.0 | Crystalline | 44.0 | 10.0 | 10.0 | 2.4 | 3.0 |
| | | | | | | | SiO₂ | | | | | |
| Powder 19 | SiO | 5.0 | Crystalline | 54.0 | 24.0 | 10.0 | 3Al₂O₃—2SiO₂ | 44.0 | 10.0 | 5.0 | 2.4 | 2.0 |
| | | | SiO₂ | | | | | | | | | |
| Powder 20 | ZrSi | 5.0 | Y₂O₃ | 54.0 | 24.0 | 11.4 | Crystalline | 44.0 | 10.0 | 10.0 | 2.4 | 1.1 |
| | | | | | | | SiO₂ | | | | | |
| Powder 21 | SiO | 5.0 | Al₂O₃ | 54.0 | 24.0 | 30.0 | Y₂O₃ | 44.0 | 10.0 | 11.4 | 2.4 | 2.6 |
| Powder 22 | AIN | 5.0 | Al₂O₃ | 54.0 | 24.0 | 30.0 | Y₂O₃ | 44.0 | 10.0 | 11.4 | 2.4 | 2.6 |
| Powder 23 | Tb₄O₇ | 5.0 | ZrO₂—Y₂O₃ | 54.0 | 24.0 | 30.0 | Amorphous | 44.0 | 10.0 | 1.5 | 2.4 | 2.4 |
| | | | | | | | SiO₂ | | | | | |
| Powder 24 | Tb₄O₇ | 25.0 | Y₂O₃ | 95.0 | 72.0 | 11.4 | Crystalline | 3.0 | 0.5 | 10.0 | 140.0 | 1.1 |
| | | | | | | | SiO₂ | | | | | |

TABLE 3

Powder mixing

| | | | | Absorber |
|---|---|---|---|---|
| Ceramic | | | | particle |
| powder | Apparatus | Conditions | | dispersity |
| Powder 1 | V blender | 26 rpm, 15 min | | 0.77 |
| Powder 2 | V blender | 26 rpm, 15 min | | 0.77 |
| Powder 3 | V blender | 26 rpm, 15 min | | 0.77 |
| Powder 4 | V blender | 26 rpm, 15 min | | 0.76 |
| Powder 5 | V blender | 26 rpm, 15 min | | 0.77 |
| Powder 6 | V blender | 26 rpm, 15 min | | 0.78 |
| Powder 7 | V blender | 26 rpm, 15 min | | 0.77 |
| Powder 8 | V blender | 26 rpm, 15 min | | 0.77 |
| Powder 9 | V blender | 26 rpm, 15 min | | 0.76 |
| Powder 10 | V blender | 26 rpm, 15 min | | 0.78 |
| Powder 11 | V blender | 26 rpm, 15 min | | 0.77 |
| Powder 12 | V blender | 26 rpm, 15 min | | 0.77 |
| Powder 13 | V blender | 26 rpm, 15 min | | 0.77 |
| Powder 14 | V blender | 26 rpm, 15 min | | 0.77 |
| Powder 15 | V blender | 26 rpm, 15 min | | 0.77 |
| Powder 16 | V blender | 26 rpm, 15 min | | 0.77 |
| Powder 17 | V blender | 26 rpm, 15 min | | 0.77 |
| Powder 18 | V blender | 26 rpm, 15 min | | 0.77 |
| Powder 19 | Rocking mixer | 120 | min | 0.80 |
| Powder 20 | Rocking mixer | 60 | min | 0.87 |
| Powder 21 | Rocking mixer | 120 | min | 0.80 |
| Powder 22 | Rocking mixer | 120 | min | 0.80 |
| Powder 23 | Rocking mixer | 120 | min | 0.80 |
| Powder 24 | Rocking mixer | 60 | min | 0.87 |

TABLE 4

| | Absorber | | | | | | | | | | Average | Thermal |
|---|---|---|---|---|---|---|---|---|---|---|---|---|
| | particles | | | | | | | | | | particle | conducti |
| | | Average | | | | | | | | | size | vity |
| | | particle | Inorganic | | | | Inorganic | | | | ratio | ratio |
| Ceramic | | size | particles A | | | | particles B | | | | D(A)/ | K(A)/ |
| powder | Constituent | (μm) | Constituent | W(A) | D(A) | K(A) | Constituent | W(B) | D(B) | K(B) | D(B) | K(B) |
| Powder 25 | N/A | | Al₂O₃ | 55.0 | 24.0 | 30.0 | Amorphous | 45.0 | 10.0 | 1.5 | 2.4 | 20.0 |
| | | | | | | | SiO₂ | | | | | |
| Powder 26 | SiO | 5.0 | Al₂O₃ | 95.0 | 24.0 | 30.0 | Amorphous | 3.0 | 10.0 | 1.5 | 2.4 | 20.0 |
| | | | | | | | SiO₂ | | | | | |
| Powder 27 | SiO | 5.0 | Al₂O₃ | 54.0 | 24.0 | 30.0 | Amorphous | 44.0 | 30.0 | 1.5 | 0.8 | 20.0 |
| | | | | | | | SiO₂ | | | | | |
| Powder 28 | SiO | 5.0 | Al₂O₃ | 95.0 | 24.0 | 30.0 | Amorphous | 3.0 | 10.0 | 1.5 | 0.8 | 20.0 |
| | | | | | | | SiO₂ | | | | | |
| Powder 29 | SiO | 5.0 | Al₂O₃ | 54.0 | 24.0 | 30.0 | Amorphous | 44.0 | 30.0 | 1.5 | 0.8 | 20.0 |
| | | | | | | | SiO₂ | | | | | |
| Powder 30 | SiO | 5.0 | Al₂O₃ | 54.0 | 24.0 | 30.0 | Amorphous | 44.0 | 30.0 | 1.5 | 0.8 | 20.0 |
| | | | | | | | SiO₂ | | | | | |
| Powder 31 | SiO | 5.0 | Al₂O₃ | 54.0 | 200.0 | 30.0 | Amorphous | 44.0 | 0.4 | 1.5 | 500 | 20.0 |
| | | | | | | | SiO₂ | | | | | |

TABLE 5

Powder mixing

| | | | Absorber |
|---|---|---|---|
| Ceramic | | | particle |
| powder | Apparatus | Conditions | dispersity |
| Powder | V blender | 26 rpm, 15 min | — |
| 25 | | | |
| Powder | V blender | 26 rpm, 15 min | 0.76 |
| 26 | | | |
| Powder | V blender | 26 rpm, 15 min | 0.77 |
| 27 | | | |
| Powder | V blender | 26 rpm, 15 min | 0.76 |
| 28 | | | |
| Powder | V blender | 26 rpm, 15 min | 0.77 |
| 29 | | | |
| Powder | V blender | 26 rpm, 15 min | 0.77 |
| 30 | | | |
| Powder | V blender | 26 rpm, 15 min | 0.77 |
| 31 | | | |

TABLE 6

| Fabricated structure | | | |
|---|---|---|---|
| 20.0 mm diameter × | 42.0 mm × 5.0 mm × | | |
| 1.0 mm thick | 6.0 mm rectangular | Powder | Firing |
| cylinder | solid | used | conditions |
| Structure 1-A | Structure 1-B | Powder 1 | 1690° C., 20 |
| | | | min |
| Structure 2-A | Structure 2-B | Powder 2 | 1690° C., 20 |
| | | | min |
| Structure 3-A | Structure 3-B | Powder 3 | 1690° C., 20 |
| | | | min |
| Structure 4-A | Structure 4-B | Powder 4 | 1690° C., 20 |
| | | | min |
| Structure 5-A | Structure 5-B | Powder 5 | 1690° C., 20 |
| | | | min |
| Structure 6-A | Structure 6-B | Powder 6 | 1690° C., 20 |
| | | | min |
| Structure 7-A | Structure 7-B | Powder 7 | 1690° C., 20 |
| | | | min |
| Structure 8-A | Structure 8-B | Powder 8 | 1690° C., 20 |
| | | | min |
| Structure 9-A | Structure 9-B | Powder 9 | 1690° C., 20 |
| | | | min |
| Structure 10-A | Structure 10-B | Powder | 1690° C., 20 |
| | | 10 | min |
| Structure 11-A | Structure 11-B | Powder | 1690° C., 20 |
| | | 11 | min |
| Structure 12-A | Structure 12-B | Powder | 1690° C., 20 |
| | | 12 | min |
| Structure 13-A | Structure 13-B | Powder | 1690° C., 20 |
| | | 13 | min |
| Structure 14-A | Structure 14-B | Powder | 1690° C., 20 |
| | | 14 | min |
| Structure 15-A | Structure 15-B | Powder | 1690° C., 20 |
| | | 15 | min |
| Structure 16-A | Structure 16-B | Powder | 1690° C., 20 |
| | | 16 | min |
| Structure 17-A | Structure 17-B | Powder | 1690° C., 20 |
| | | 17 | min |
| Structure 18-A | Structure 18-B | Powder | 1690° C., 20 |
| | | 18 | min |
| Structure 19-A | Structure 19-B | Powder | 1690° C., 20 |
| | | 19 | min |
| Structure 20-A | Structure 20-B | Powder | 1690° C., 20 |
| | | 20 | min |
| Structure 21-A | Structure 21-B | Powder | 1690° C., 20 |
| | | 21 | min |
| Structure 22-A | Structure 22-B | Powder | 1690° C., 20 |
| | | 22 | min |
| Structure 23-A | Structure 23-B | Powder | 1690° C., 20 |
| | | 23 | min |
| Structure 24-A | Structure 24-B | Powder | 1690° C., 20 |
| | | 24 | min |
| Structure 25-A | Structure 25-B | Powder | 1690° C., 20 |
| | | 25 | min |
| Structure 26-A | Structure 26-B | Powder | 1690° C., 20 |
| | | 26 | min |
| Structure 27-A | Structure 27-B | Powder | 1690° C., 20 |
| | | 27 | min |
| Structure 28-A | Structure 28-B | Powder | 1690° C., 20 |
| | | 28 | min |
| Structure 29-A | Structure 29-B | Powder | 1720° C., 20 |
| | | 29 | min |
| Structure 30-A | Structure 30-B | Powder | 1740° C., 20 |
| | | 30 | min |
| Structure 31-A | Structure 31-B | Powder | 1690° C., 20 |
| | | 31 | min |

TABLE 7

| Example/ | | Voidage | | Porosity | Dielectric | |
|---|---|---|---|---|---|---|
| Comparative | Ceramic | | Measurement | Measurement | loss tangent | |
| Example | structure | Rank | (%) | (%) | Rank | Measurement |
| Example 1 | Structure | A | 3 | 1 | A | 0.002 |
| | 1-A | | | | | |
| Example 2 | Structure | A | 2 | 1 | A | 0.001 |
| | 2-A | | | | | |
| Example 3 | Structure | A | 2 | 1 | A | 0.001 |
| | 3-A | | | | | |
| Example 4 | Structure | A | 7 | 2 | A | 0.003 |
| | 4-A | | | | | |
| Example 5 | Structure | A | 9 | 2 | A | 0.004 |
| | 5-A | | | | | |
| Example 6 | Structure | B | 14 | 3 | B | 0.007 |
| | 6-A | | | | | |
| Example 7 | Structure | C | 17 | 4 | C | 0.008 |
| | 7-A | | | | | |
| Example 8 | Structure | A | 3 | 1 | A | 0.002 |
| | 8-A | | | | | |
| Example 9 | Structure | A | 2 | 1 | A | 0.001 |
| | 9-A | | | | | |
| Example 10 | Structure | A | 2 | 1 | A | 0.001 |
| | 10-A | | | | | |
| Example 11 | Structure | A | 1 | 1 | A | 0.001 |
| | 11-A | | | | | |
| Example 12 | Structure | A | 7 | 2 | A | 0.003 |
| | 12-A | | | | | |
| Example 13 | Structure | A | 9 | 2 | A | 0.004 |
| | 13-A | | | | | |
| Example 14 | Structure | B | 13 | 3 | B | 0.006 |
| | 14-A | | | | | |
| Example 15 | Structure | A | 4 | 1 | A | 0.002 |
| | 15-A | | | | | |
| Example 16 | Structure | A | 4 | 1 | A | 0.002 |
| | 16-A | | | | | |
| Example 17 | Structure | A | 4 | 1 | A | 0.002 |
| | 17-A | | | | | |
| Example 18 | Structure | A | 6 | 2 | A | 0.004 |
| | 18-A | | | | | |
| Example 19 | Structure | B | 14 | 2 | B | 0.007 |
| | 19-A | | | | | |
| Example 20 | Structure | C | 15 | 4 | C | 0.008 |
| | 20-A | | | | | |
| Example 21 | Structure | B | 13 | 4 | B | 0.006 |
| | 21-A | | | | | |
| Example 22 | Structure | B | 13 | 4 | B | 0.006 |
| | 22-A | | | | | |
| Example 23 | Structure | B | 13 | 1 | B | 0.006 |
| | 23-A | | | | | |
| Example 24 | Structure | C | 19 | 5 | C | 0.009 |
| | 24-A | | | | | |
| Comparative | Structure | N/A, Powder not melted by | | | | |
| Example 1 | 25-A | laser irradiation | | | | |
| Comparative | Structure | D | 28 | 5 | D | 0.015 |
| Example 2 | 26-A | | | | | |
| Comparative | Structure | D | 30 | 3 | D | 0.016 |
| Example 3 | 27-A | | | | | |
| Comparative | Structure | D | 31 | 3 | D | 0.016 |
| Example 4 | 28-A | | | | | |
| Comparative | Structure | D | 26 | 2 | D | 0.013 |
| Example 5 | 29-A | | | | | |
| Comparative | Structure | D | 22 | 2 | D | 0.012 |
| Example 6 | 30-A | | | | | |

| | | |
|---|---|---|
| Comparative | Structure | N/A, Powder not melted by |
| Example 7 | 31-A | laser irradiation |

TABLE 8

| | | Surface | | Dimensional | | Flexural |
|---|---|---|---|---|---|---|
| Example/ | | roughness (Ra) | | stability | | strength |
| Comparative | Ceramic | | Measurement | | Measurement | Measurement |
| Example | structure | Rank | (μm) | Rank | (%) | (MPa) |
| Example 1 | Structure | A | 7 | A | 5 | 100 |
| | 1-B | | | | | |
| Example 2 | Structure | A | 7 | A | 9 | 95 |
| | 2-B | | | | | |
| Example 3 | Structure | A | 8 | B | 13 | 92 |
| | 3-B | | | | | |
| Example 4 | Structure | A | 7 | A | 4 | 90 |
| | 4-B | | | | | |
| Example 5 | Structure | A | 8 | A | 3 | 92 |
| | 5-B | | | | | |
| Example 6 | Structure | A | 7 | A | 6 | 88 |
| | 6-B | | | | | |
| Example 7 | Structure | A | 6 | A | 5 | 82 |
| | 7-B | | | | | |
| Example 8 | Structure | A | 7 | A | 6 | 103 |
| | 8-B | | | | | |
| Example 9 | Structure | A | 6 | A | 9 | 102 |
| | 9-B | | | | | |
| Example 10 | Structure | A | 7 | B | 14 | 104 |
| | 10-B | | | | | |
| Example 11 | Structure | A | 7 | C | 18 | 105 |
| | 11-B | | | | | |
| Example 12 | Structure | A | 8 | A | 5 | 97 |
| | 12-B | | | | | |
| Example 13 | Structure | A | 7 | A | 6 | 96 |
| | 13-B | | | | | |
| Example 14 | Structure | A | 7 | A | 7 | 96 |
| | 14-B | | | | | |
| Example 15 | Structure | A | 7 | A | 6 | 102 |
| | 15-B | | | | | |
| Example 16 | Structure | B | 15 | A | 5 | 101 |
| | 16-B | | | | | |
| Example 17 | Structure | C | 26 | A | 7 | 100 |
| | 17-B | | | | | |
| Example 18 | Structure | A | 7 | A | 6 | 98 |
| | 18-B | | | | | |
| Example 19 | Structure | A | 8 | A | 7 | 100 |
| | 19-B | | | | | |
| Example 20 | Structure | C | 23 | A | 8 | 45 |
| | 20-B | | | | | |
| Example 21 | Structure | A | 6 | A | 7 | 47 |
| | 21-B | | | | | |
| Example 22 | Structure | C | 24 | A | 8 | 45 |
| | 22-B | | | | | |
| Example 23 | Structure | C | 27 | C | 19 | 42 |
| | 23-B | | | | | |
| Example 24 | Structure | C | 30 | C | 19 | 40 |
| | 24-B | | | | | |
| Comparative | Structure | N/A, Powder not melted by | | | | |
| Example 1 | 25-B | laser irradiation | | | | |
| Comparative | Structure | C | 25 | A | 6 | 39 |
| Example 2 | 26-B | | | | | |
| Comparative | Structure | C | 24 | A | 7 | 38 |
| Example 3 | 27-B | | | | | |
| Comparative | Structure | C | 27 | A | 7 | 34 |
| Example 4 | 28-B | | | | | |
| Comparative | Structure | C | 26 | C | 17 | 37 |
| Example 5 | 29-B | | | | | |
| Comparative | Structure | C | 23 | D | 25 | 35 |
| Example 6 | 30-B | | | | | |

| | | |
|---|---|---|
| Comparative | Structure | N/A, Powder not melted by |
| Example 7 | 31-B | laser irradiation |

Using the powder of the present disclosure as a raw material powder in additive manufacturing technology enables the fabrication of ceramic structures with a low dielectric loss tangent at high precision.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A powder used in an additive manufacturing method in which fabrication is performed by heating, the powder comprising:
particles A of a first inorganic compound; and
particles B of a second inorganic compound,
the particles B have a smaller particle size than the particles A, and
the powder satisfies relationships (1) to (4):
$$5. \leq W ( A ) ; \qquad ( 1 )$$
$$5. \leq W ( B ) ; \qquad ( 2 )$$
$$60. \leq W ( A ) + W ( B ) ; and \qquad ( 3 )$$
$$D ( A ) / D ( B ) \leq 400 , \qquad ( 4 )$$
wherein D(A) represents the average particle size in μm of the particles A, D(B) represents the average particle size in μm of the particles B, W(A) represents the mass percent of the particles A in % by weight in the powder, and W(B) represents the mass percent of the particles B in % by weight.

2. The powder according to claim 1, wherein the second inorganic compound has a lower thermal conductivity than the first inorganic compound and a lower melting point than the first inorganic compound.

3. The powder according to claim 1, wherein the second inorganic compound has a lower thermal conductivity than the first inorganic compound, and the second inorganic compound has a lower specific gravity than the first inorganic compound.

4. The powder according to claim 1, wherein the second inorganic compound has a lower thermal conductivity than the first inorganic compound.

5. The powder according to claim 1, wherein the second inorganic compound has a melting point of 1900° C. or less, and the second inorganic compound has lower thermal conductivity than the first inorganic compound.

6. The powder according to claim 1, wherein the value of D(A)/D(B) is 1.2 or more.

7. The powder according to claim 1, wherein the value of D(A)/D(B) is 150 or less.

8. The powder according to claim 1, wherein the value of D(A)/D(B) is 60 or less.

9. The powder according to claim 1, wherein the first inorganic compound and the second inorganic compound have a thermal conductivity of K(A) and a thermal conductivity of K(B), respectively, and K(A)/K(B) ranges from 2.0 to 50.0.

10. The powder according to claim 1, wherein the particles B contain the second inorganic compound that is amorphous.

11. The powder according to claim 1, wherein the first inorganic compound is metal oxide and/or semimetal oxide, and the second inorganic compound is metal oxide and/or semimetal oxide.

12. The powder according to claim 1, wherein the particles A contain a composition that form a eutectic with the composition of the particles B.

13. The powder according to claim 1, wherein the particles B have a lower melting point than the particles A.

14. The powder according to claim 1, wherein the value of W(B) ranges from 10.0 [% by weight] to 90.0 [% by weight].

15. The powder according to claim 1, the powder containing absorber particles exhibiting higher absorptive capacity for light with wavelengths present in the laser light than the particles A and the particles B.

16. The powder according to claim 11, wherein the absorber particles contain an element same as the semimetal element or metal element contained in the particles A or the particles B.

17. The powder according to claim 15 wherein the absorber particles exhibit an absorptance of 10% or more for the light.

18. The powder according to claim 15, wherein the absorber particles contain at least one selected from the group consisting of SiO, TiO, Ti₂O₃, ZnO, antimony-doped tin oxide (ATO), indium-doped tin oxide (ITO), MnO, MnO₂, Mn₂O₃, Mn₃O₄, FeO, Fe₂O₃, Fe₃O₄, Cu₂O, CuO, Cr₂O₃, CrO₃, NiO, V₂O₃, VO₂, V₂O₅, V₂O₄, Co₃O₄, CoO, Tb₄O₇, Pr₆O₁₁, ZrN, ZrC, ZrSi, and AlN.

19. The powder according to claim 15, wherein the absorber particles contain SiO.

20. The powder according to claim 1, wherein the particles B have a melting point of 1900° C. or less.

21. The powder according to claim 1, wherein the particles A contain aluminum oxide, and the particles B contain silicon dioxide.

22. The powder according to claim 1, wherein W(A) is larger than W(B).

23. A method for manufacturing a ceramic structure, comprising: performing a powder bed fusion method for fabrication using the powder as set forth in claim 1.

24. A method for manufacturing a ceramic structure, comprising: irradiating the powder as set forth in claim 1 to heat the powder for fabrication.

25. The powder according to claim 1, wherein the first inorganic compound is aluminum oxide, and the second inorganic compound is silicon dioxide.
